(19) United States
(12) Patent Application Publication
(10) Pub. No.: US 2018/0295262 A1
(43) Pub. Date: Oct. 11, 2018

(54) CONDUCTIVE EMI-SHIELD HOUSINGS FOR VEHICLE CAMERAS

(71) Applicant: Ford Global Technologies, LLC, Dearborn, MI (US)

(72) Inventors: Paul Kenneth Dellock, Northville, MI (US); Pietro Buttolo, Dearborn Heights, MI (US); Stuart C. Salter, White Lake, MI (US); Talat Karmo, Waterford, MI (US)

(21) Appl. No.: 15/481,274

(22) Filed: Apr. 6, 2017

(51) Int. Cl. H04N 5/225; H04N 5/232; H04N 5/77; H04N 7/18; H04N 5/247

(52) U.S. Cl. CPC H04N 5/2251; H04N 5/23296; B60R 2001/1253; H04N 7/181; H04N 5/247; H04N 5/77

(57) ABSTRACT

Method and apparatus are disclosed for conductive EMI-shield housings for vehicle cameras. An example method for forming conductive EMI-shield housings for vehicle cameras includes heating a molding tool to within a predetermined range of a melting point of polymer resin, adding conductive material to the polymer resin to form impregnated resin, injecting the impregnated resin into a mold of the molding tool, and cooling the molding tool until the impregnated resin solidifies to form a conductive EMI-shield housing.

### TECHNICAL FIELD

The present disclosure generally relates to cameras and, more specifically, to conductive EMI-shield housings for vehicle cameras.

### BACKGROUND

Oftentimes, vehicles include cameras (e.g., digital cameras, analog cameras) that capture image(s) and/or video. In some instances, the image(s) and/or video captured via the cameras are presented to a driver (e.g., via a center console display) to facilitate the driver in operating the vehicle. Additionally or alternatively, the image(s) and/or video captured via the cameras are analyzed by a vehicle module to enable autonomous and/or semi-autonomous motive functions to be performed by the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for conductive EMI-shield housings for vehicle cameras. An example disclosed vehicle camera includes a lens, a ground connection, and an EMI-shield housing defining a cavity in which the lens and the ground connection are housed. The EMI-shield housing includes a body and a cover coupled to the body. Each of the body and the cover includes a graphite-impregnated polymer that is conductive. The cover includes a contact point that contacts the ground connection to ground the EMI-shield housing.

An example disclosed method for forming conductive EMI-shield housings for vehicle cameras includes heating a molding tool to within a predetermined range of a melting point of polymer resin, adding conductive material to the polymer resin to form impregnated resin, injecting the impregnated resin into a mold of the molding tool, and cooling the molding tool until the impregnated resin solidifies to form a conductive EMI-shield housing.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 illustrates an example camera of the vehicle of FIG. 1.

FIG. 3 illustrates an example injection molding tool to form an EMI-shield housing of the camera of FIG. 2.

FIG. 4 is a flowchart for forming an EMI-shield housing of a camera via an injection molding tool in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Oftentimes, vehicles include cameras (e.g., digital cameras, analog cameras) that capture image(s) and/or video. In some instances, the image(s) and/or video captured via the cameras are presented to a driver (e.g., via a center console display) to facilitate the driver in operating the vehicle. Additionally or alternatively, the image(s) and/or video captured via the cameras are analyzed by a vehicle module to enable autonomous and/or semi-autonomous motive functions to be performed by the vehicle.

In some instances, electromagnetic interference potentially may cause image(s) and/or video captured via a camera potentially may become distorted as a result electromagnetic interference (EMI). The EMI may originate from other electrical components of the vehicle such as displays, LED lighting, radio antennas, light-emitting diodes (LEDs), communication modules, motor bushes, etc. Some cameras include a shield (e.g., vacuum metalizing the housing, a metallic foil) that is connected to ground to block the image and/or video signals from being distorted by the EMI. However, in such instances, the shield increases the number of components of the housing, thereby potentially increasing manufacturing costs and/or assembly time.

Example vehicle cameras disclosed herein include an EMI-shield housing. The EMI-shield housing shields electrical components of the vehicle camera from electromagnetic interference to prevent image(s) and/or video captured via the vehicle camera from being distorted. The EMI-shield housing of the example vehicle cameras disclosed herein include a base and a cover that define a cavity in which the electrical components of the vehicle camera are housed. The base and the cover are formed of a polymer that is impregnated with conductive material (e.g., graphite, carbon black, boron nitrile, aluminum nitrile, carbon nano-tubes, etc.) to enable the EMI-shield housing to be grounded by connecting to a ground connection.

The base and the cover of the EMI-shield housing are formed via example injection molding methods disclosed herein that cause outer surfaces of the base and the cover, respectively, to be conductive. Example methods disclosed herein to form the base and the cover of the EMI-shield housing include heating an injection molding tool to a temperature within a predetermined range of the polymer, injecting the polymer impregnated with the conductive material into a mold of the heated injection molding tool, and cooling the injection molding tool until the polymer impregnated with the conductive material solidifies into the component of the EMI-shield housing. The injection molding tool is heated prior to injecting the polymer impregnated with the conductive material into the mold to facilitate some of the conductive material in remaining positioned along the outer surface of the component to cause the outer surface of the component to be conductive.

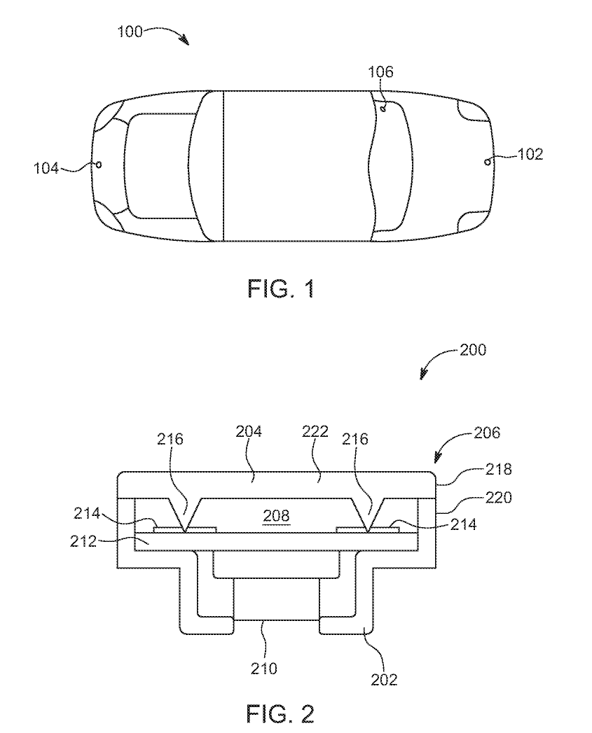

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a camera 102, a camera 104, and a camera 106. For example, the camera 102 is a front camera located on an exterior of the vehicle 100 to capture image(s) and/or video of a surrounding area in front of the vehicle 100. The image(s) and/or video captured by the camera 102 may be utilized to perform autonomous and/or semi-autonomous driving functions such as adaptive cruise control or active park assist. The camera 104 is a rear camera located on an exterior of the vehicle 100 to capture image(s) and/or video of a surrounding area behind the vehicle 100. The image(s) and/or video captured by the camera 104 may be utilized to perform autonomous and/or semi-autonomous driving functions such as activate park assist. Additionally or alternatively, the image(s) and/or video captured by the camera 104 may be presented via a center console display when the vehicle 100 is driving in reverse. Further, the camera 106 is located within a cabin of the vehicle 100, for example, to monitor a driver of the vehicle 100. In some examples, the camera 106 may capture the image(s) and/or video of the driver to measure biometrics of the driver operating the vehicle 100.

FIG. 2 illustrates an example camera 200 (e.g., a digital camera, an analog camera) of the vehicle 100. For example, the camera 200 is the camera 102, the camera 104, the camera 106 and/or any other camera of the vehicle 100. As illustrated in FIG. 2, the camera 200 includes a body 202 and a cover 204 that form an EMI-shield housing 206 of the camera 200. The body 202 and the cover 204 of the EMI-shield housing 206 define a cavity 208 of the camera 200. As illustrated in FIG. 2, a lens 210, a circuit board 212 (e.g., a printed circuit board), and one or more ground connections 214 are housed or disposed in the cavity 208 of the camera 200. In the illustrated example, the lens 210 and the ground connections 214 are coupled to the circuit board 212. The lens 210 collects image(s) and/or video for the camera 200. The circuit board 212 includes circuitry (e.g., one or more integrated circuits, microprocessors, memory, storage, etc.) to collect, process, store, analyze, and/or send image(s) and/or video captured via the lens 210. Further, the ground connections 214 are connected to ground.

The body 202 and the cover 204 of the EMI-shield housing 206 are formed of a polymer that is impregnated with conductive material (e.g., graphite, carbon black, carbon black, boron nitrile, aluminum nitrile, carbon nano-tubes, etc.). The polymer has a melting point (e.g., about 130 degrees Celsius, about 170 degrees Celsius, about 200 degrees Celsius, about 220 degrees Celsius, about 250 degrees Celsius) to enable the EMI-shield housing 206 to retain its shape when exposed to heat emitted by electronic components within and/or nearby the EMI-shield housing 206 for an extended period of time. For example, the EMI-shield housing 206 includes a polymer, such as a thermoplastic compound, that is lightweight and can withstand elevated temperatures for an extended period of time. The conductive material of the body 202 and the cover 204 enable the EMI-shield housing 206 to shield the lens 210, the circuit board 212, the ground connections 214, and/or any other electronic components of the camera 200 located within the cavity 208 from electromagnetic interference. For example, when the EMI-shield housing 206 is grounded (e.g., by connecting one or contact points 216 of the cover 204 to the one or more ground connections 214), the conductive material shields the lens 210, the circuit board 212, and the ground connections 214 from EMI deriving from television transmissions, radio (e.g., AM, FM, satellite) transmissions, lighting, power grid transmissions lines, motor bushes, wireless communication, physical contact with other electrical components located within and/or near the vehicle 100 to prevent image(s) and/or video captured via the camera 200 from being distorted.

In the illustrated example, the polymer of the body 202 and the cover 204 of the EMI-shield housing 206 is impregnated with the conductive material (e.g., a graphite-impregnated polymer). The impregnated polymer of the body 202 and the cover 204 enables the EMI-shield housing 206 to be grounded without additional components (e.g., a conductive foil or layer). That is, the body 202 and the cover 204 both house the components of the camera 200 and connect to ground to shield the electronic components of the camera 200.

Further, the conductive material is distributed (e.g., substantially evenly) throughout the polymer of the body 202 and the cover 204 such that the conductive material is positioned along an outer surface 218 of the body 202 and an outer surface 220 of the cover 204. Because the conductive material is positioned along the outer surface 218 and the outer surface 220, the outer surface 218 of the body 202 and the outer surface 220 of the cover 204 are conductive. That is, the outer surface 218 is a conductive outer surface of the body 202, and the outer surface 220 is conductive outer surfaces of the cover 204. The body 202 does not include a polymer-rich layer extending along the outer surface 218 and the cover 204 does not include a polymer-rich layer extending along the outer surface 220 that would prevent the outer surface 218 and the outer surface 220, respectively, from conducting electricity.

In the illustrated example, the cover 204 includes a base 222 and the one or more contact points 216 that extend from and are integrally formed with the base 222. Both the contact points 216 and the base 222 include the polymer impregnated with conductive material such that both portions of the outer surface 220 that extend along the base 222 and portions of the outer surface 220 that extend along the contact points 216 are conductive. The contact points 216 contact the ground connections 214 to ground the EMI-shield housing 206. Because the outer surface 220 that extend along the contact points 216 is conductive, the contact points 216 ground the cover 204 when the contact points 216 contact the ground connections 214. Further, a portion of the outer surface 218 of the body 202 contacts a portion of the outer surface 220 of the cover 204 when the EMI-shield housing 206 is assembled to electrically connect the cover 204 and the body 202. Because the outer surface 218 and the outer surface 220 are conductive, the body 202 is grounded when the cover 204 is coupled to the body 202 and the contact points 216 contact the ground connections 214.

To assemble the EMI-shield housing 206, the lens 210, the circuit board 212, and the ground connections 214 are inserted into the cavity 208. For example, the lens 210 is inserted into to the cavity 208, and the circuit board 212 subsequently is press fit into the cavity 208 to retain the position of the lens 210 and the circuit board 212 within the cavity 208. After the electronics of the camera 200 are positioned within the cavity 208, the cover 204 is coupled to the body 202 such that the contact points 216 contact the ground connections 214 and the outer surface 220 of the cover 204 couples to the outer surface 218 of the body 202. In some examples, the cover 204 is welds to the body 202 to form the EMI-shield housing 206.

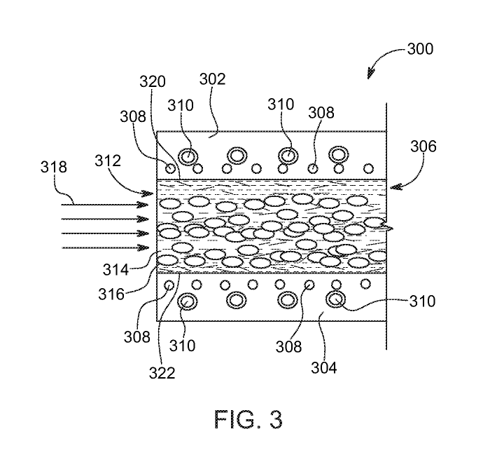

FIG. 3 illustrates an example injection molding tool 300 to form the body 202 and/or the cover 204 of the EMI-shield housing 206 of the camera 200. The injection molding tool 300 includes a first portion 302 (e.g., a first body, a first half) and a second portion 304 (e.g., a second body, a second portion) opposite the first portion 302 that form a mold 306. As illustrated in FIG. 3, each of the first portion 302 and the second portion 304 include one or more heating rods 308 and one or more cooling pipes 310. In the illustrated example, the heating rods 308 and the cooling pipes 310 are embedded in the injection molding tool 300. The heating rods 308 are activated to heat the injection molding tool 300, and the cooling pipes 310 are activated to cool the injection molding tool 300.

In the illustrated example, impregnated resin 312 is injected into the mold 306 of the injection molding tool 300 to form the components (e.g., body 202, the cover 204) of the EMI-shield housing 206. In the illustrated example, the impregnated resin 312 is graphite-impregnated resin that includes a polymer resin 314 impregnated with graphite 316. The graphite 316 is added to the polymer resin 314 to increase an electrical conductivity of the material that forms the components of the EMI-shield housing 206. In the illustrated example, the polymer resin 314 includes polyethylene terephthalate (PET), and the graphite 316 includes high-aspect-ratio flakes of graphite. For example, impregnating PET with high-aspect-ratio flakes of graphite decreases an electrical volume resistivity of the material from about 10¹⁶ Ohms-centimeter to about 10² Ohm-centimeter. Further, the graphite 316 increases a heat stability of the polymer resin 314 such that the components of the EMI-shield housing 206 remain dimensionally stable and prevent distortion of optics when exposed to heat and pressure over time. In other examples, the polymer resin 314 includes a different type of polymer and/or the polymer resin 314 is impregnated with a different type of conductive material (e.g., spherical-shaped graphite, graphite flakes, carbon black, boron nitrile, aluminum nitrile, carbon nano-tubes, etc.).

As illustrated in FIG. 3, the impregnated resin 312 flows into the mold 306 in a direction 318. Prior to injecting the impregnated resin 312 into the mold 306, the injection molding tool 300 is heated to within a predetermined range of a melting point of the polymer resin 314. For example, the heating rods 308 embedded in the injection molding tool 300 are activated to heat the first portion 302 and the second portion 304 of the injection molding tool 300 to be within the predetermined range. The injection molding tool 300 is heated to within the predetermined range of the melting point of the polymer resin 314 to prevent the graphite 316 from collecting toward a center of mold 306 prior to solidifying into a component of the EMI-shield housing 206. That is, the injection molding tool 300 is heated to within the predetermined range of the melting point prior to injecting the impregnated resin 312 to increase conductivity of outer surface of the component of the EMI-shield housing 206 (e.g., the outer surface 218 of the body 202, the outer surface 220 of the cover 204) by deterring a non-conductive resin layer (e.g., a polymer-rich layer) from forming along a surface 320 of the first portion 302 and/or a surface 322 of the second portion 304.

The impregnated resin 312 of the illustrated example is injected into the mold 306 when the injection molding tool 300 (e.g., the surface 320 of the first portion 302 and the surface 322 of the second portion 304) are within 20 degrees Celsius of the melting point of the polymer resin 314. In some examples, the polymer resin 314 is PET that has a melting point of about 250 degrees Celsius. In such examples, the impregnated resin 312 is injected into the mold 306 when the injection molding tool 300 is between about 230 degrees Celsius and 270 degrees Celsius. In other examples, the polymer resin 314 is formed of another type of polymer. Table 1 provided below includes polymers that may form the polymer resin 314 and their corresponding melting points.

TABLE 1

| Polymer Type | Melting Point |
|---|---|
| Acetal Copolymer | 200° C. (392° F.) |
| Acetal Copolymer and 30% Glass Fiber | 200° C. (392° F.) |
| Acrylic | 130° C. (266° F.) |
| Nylon 6 | 220° C. (428° F.) |
| Nylon 6 and 30% Glass Fiber | 220° C. (428° F.) |
| High-Density Polyethylene (HDPE) | 130° C. (266° F.) |
| Polyethylene Terephthalate (PET) | 250° C. (482° F.) |
| PET and 30% Glass Fiber | 250° C. (482° F.) |
| Polypropylene and 30% Glass Fiber | 160° C. (320° F.) |
| Polystyrene | 170° C. (338° F.) |

As illustrated above in Table 1, the polymer resin 314 includes HDPE that has a melting point of about 130 degrees Celsius. In such examples, the impregnated resin 312 is injected into the mold 306 when the injection molding tool 300 is between about 110 degrees Celsius and 150 degrees Celsius. Further, in other examples, the polymer resin 314 includes other polymer types not included in Table 1, such as acrylonitrile butadiene styrene (ABS), ABS and 30% glass fiber, polycarbonate, polystyrene, etc.

After the injection molding tool 300 is heated to within the predetermined range of the melting point of the polymer resin 314, the impregnated resin 312 is injected into the mold 306. Upon the mold 306 being filled with the impregnated resin 312, the injection molding tool 300 is cooled to solidify the impregnated resin 312 into the component of the EMI-shield housing 206. For example, to cool the injection molding tool 300, the heating rods 308 are deactivated and the cooling pipes 310 are activated. The cooling pipes 310 are activated by pulsing cold liquid (e.g., water) through the cooling pipes 310. The injection molding tool 300 is cooled via the cooling pipes 310 until the impregnated resin 312 is solidified into the component of the EMI-shield housing 206, which has a conductive outer surface as a result of heating the injection molding tool 300 prior to injection of the impregnated resin 312.

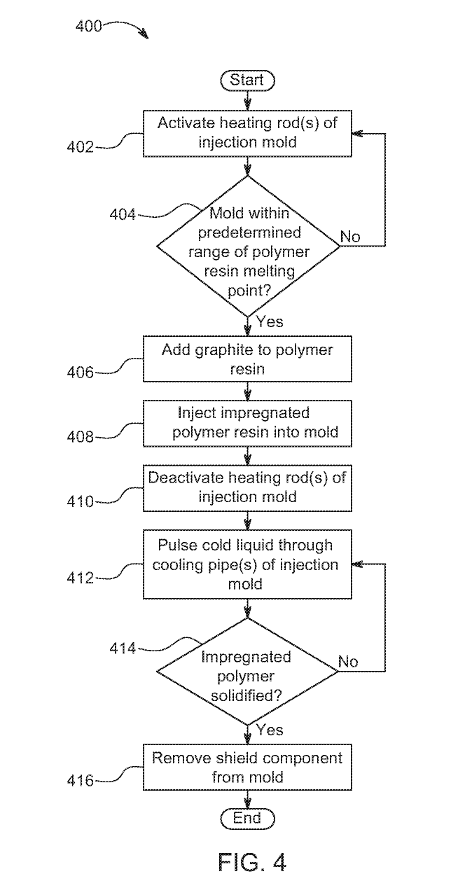

FIG. 4 is a flowchart of an example method 400 to form an EMI-shield housing of a camera via an injection molding tool. For example, the flowchart of FIG. 4 is representative of machine readable instructions that are stored in memory and include one or more programs which, when executed by a processor, cause the injection molding tool 300 to forming the body 202 and/or the cover 204 of the EMI-shield housing 206 of the camera 200 of FIG. 2. While the example method is described with reference to the flowchart illustrated in FIG. 4, many other methods of forming the EMI-shield housing 206 of the camera 200 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Initially, at block 402, one or more of the heating rods 308 are activated to heat the injection molding tool 300. For example, one or more of the heating rods 308 are activated to heat the first portion 302 of the injection molding tool 300, and another one or more of the heating rods 308 are activated to heat the second portion 304 of the injection molding tool 300. At block 404, the method 400 includes determining whether the injection molding tool 300 is heated to a temperature that is within a predetermined range (e.g., +/−20 degrees Celsius of the melting point of the polymer resin 314. Responsive to the injection molding tool 300 not being within the predetermined range, the method 400 returns to block 402. Otherwise, responsive to the injection molding tool 300 being within the predetermined range, the method 400 proceeds to block 406 at which the graphite 316 and/or other conductive material(s) (e.g., carbon black, boron nitrile, aluminum nitrile, carbon nano-tubes, etc.) are added to the polymer resin 314 to form the impregnated resin 312.

At block 408, the impregnated resin 312 is injected into the mold 306 of the injection molding tool 300. For example, the impregnated resin 312 is injected into the mold 306 while the surface 320 of the first portion 302 and the surface 322 of the second portion 304 of the injection molding tool 300 are within the predetermined range of the melting point of the polymer resin 314. Upon filling the mold 306 within the impregnated resin 312, the injection molding tool 300 is cooled. At block 410, the heating rods 308 are deactivated to cool the first portion 302 and the second portion 304 of the injection molding tool 300. Further, at block 412, the cooling pipes 310 are activated to cool the injection molding tool 300. For example, one or more of the cooling pipes 310 are activated to cool the surface 320 of the first portion 302 of the injection molding tool 300, and one or more of the cooling pipes 310 are activated to cool the surface 322 of the second portion 304 of the injection molding tool 300. The cooling pipes 310 are activated to cool the injection molding tool 300 by pulsing cool liquid (e.g., water) through the cooling pipes 310.

At block 414, the method 400 includes monitoring the impregnated resin 312 within the mold 306 to determine whether the impregnated resin 312 has solidified into a component (e.g., the body 202, the cover 204) of the EMI-shield housing 206 of the camera 200 (e.g., the camera 102, the camera 104, the camera 106). The impregnated resin 312 contained within the mold 306 solidifies as a result of being cooled via the activation of the cooling pipes 310 and/or the deactivation of the heating rods 308. Responsive to determining that the impregnated resin 312 has not solidified, the method 400 returns to block 412 to continue cooling of the impregnated resin 312. Otherwise, responsive to determining that the impregnated resin 312 has solidified, the method 400 proceeds to block 416 at which the component of the EMI-shield housing 206 formed from the impregnated resin 312 that has solidified is removed from the mold 306 of the injection molding tool 300.

For example, the impregnated resin 312 is monitored and removed from the mold 306 when the

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1-5. (canceled)

6. A method for forming conductive EMI-shield housings for vehicle cameras, the method comprising:
heating a molding tool to within a predetermined range of a melting point of polymer resin;
adding conductive material to the polymer resin to form impregnated resin;
injecting the impregnated resin into a mold of the molding tool; and
cooling the molding tool until the impregnated resin solidifies to form a conductive EMI-shield housing.

7. The method of claim 6, wherein the impregnated resin is injected into the mold while the molding tool is within the predetermined range of the polymer resin.

8. The method of claim 7, wherein injecting the impregnated resin into the mold of the molding tool deters a resin layer from forming along a surface of the mold to increase conductivity of an outer surface of the conductive EMI-shield housing.

9. The method of claim 6, wherein heating the molding tool includes activating a heating rod embedded in the molding tool.

10. The method of claim 9, wherein cooling the molding tool includes deactivating the heating rod.

11. The method of claim 10, wherein the heating rod is deactivated upon the mold being filled with the impregnated resin.

12. The method of claim 6, wherein cooling the molding tool includes activating a cooling pipe embedded in the molding tool.

13. The method of claim 12, wherein activating the cooling pipe includes pulsing cold liquid through the cooling pipe.

14. The method of claim 6, wherein the polymer resin is polyethylene terephthalate.

15. The method of claim 6, wherein the melting point of the polymer resin is about 250 degrees Celsius.

16. The method of claim 15, wherein the predetermined range is about between 230 degrees Celsius and 270 degrees Celsius.

17. The method of claim 6, wherein the conductive material added to the polymer resin includes high-aspect-ratio flakes of graphite to increase an electrical conductivity of the conductive EMI-shield housing formed from the impregnated resin.

18. The method of claim 6, further including monitoring the impregnated resin within the mold and removing the conductive EMI-shield housing when the impregnated resin is solidified.

19. The method of claim 6, wherein heating the molding tool includes heating a first portion and a second portion of the molding tool, the first portion and the second portion defining the mold of the molding tool.

20. The method of claim 19, wherein cooling the molding tool includes cooling the first portion and the second portion of the molding tool.

21. The method of claim 6, wherein the conductive EMI-shield housing is formed to define a cavity in which a lens and a ground connection of a vehicle camera are housed.

22. The method of claim 21, wherein the conductive EMI-shield housing is formed to include a contact point that is configured to contact the ground connection.

23. The method of claim 22, wherein the contact point of the conductive EMI-shield housing is formed to include the impregnated resin that is conductive.

24. The method of claim 6, wherein the molding tool is heated before the conductive material is added to the polymer resin to evenly distribute the conductive material throughout the conductive EMI-shield housing that is formed.

25. The method of claim 6, wherein the molding tool is heated before the conductive material is added to the polymer resin to distribute the conductive material to an outer surface of the conductive EMI-shield housing that is formed.
